(19) United States
(12) Patent Application Publication
(10) Pub. No.: US 2022/0113671 A1
(43) Pub. Date: Apr. 14, 2022

(54) PORTABLE UV HOLOGRAPHIC MICROSCOPE FOR HIGH-CONTRAST PROTEIN CRYSTAL IMAGING

(71) Applicant: THE REGENTS OF THE UNIVERSITY OF CALIFORNIA, Oakland, CA (US)

(72) Inventors: Aydogan Ozcan, Los Angeles, CA (US); Aniruddha Ray, Los Angeles, CA (US); Mustafa Daloglu, Los Angeles, CA (US)

(73) Assignee: THE REGENTS OF THE UNIVERSITY OF CALIFORNIA, Oakland, CA (US)

(21) Appl. No.: 17/298,182

(22) PCT Filed: Dec. 3, 2019
(86) PCT No.: PCT/US2019/064321

§ 371 Date: May 28, 2021

Related U.S. Application Data
(60) Provisional application No. 62/775,005, filed on Dec. 4, 2018.

(51) Int. Cl. G03H 1/00; G02B 21/36; G02B 21/16

(52) U.S. Cl. CPC G03H 1/0005; G02B 21/365; G03H 2227/02; G03H 2001/005; G02B 21/16

(57) ABSTRACT

A UV holographic imaging device offers a low-cost, portable and robust technique to image and distinguish protein crystals from salt crystals, without the need for any expensive and bulky optical components. This “on-chip” device uses a UV LED and a consumer-grade CMOS image sensor de-capped and interfaced to a processor or microcontroller, the information from the crystal samples, which are placed very close to the sensor active area, is captured in the form of in-line holograms and extracted through digital back-propagation. In these holographic amplitude and/or phase reconstructions, protein crystals appear significantly darker compared to the background due to the strong UV absorption, unlike salt crystals, enabling one to clearly distinguish protein and salt crystals. The on-chip UV holographic microscope serves as a low-cost, sensitive, and robust alternative to conventional lens-based UV-microscopes used in protein crystallography.

### RELATED APPLICATION

This application claims priority to U.S. Provisional Patent Application No. 62/775,005 filed on Dec. 4, 2018, which is hereby incorporated by reference in its entirety. Priority is claimed pursuant to 35 U.S.C. § 119 and any other applicable statute.

### TECHNICAL FIELD

The technical field generally relates to holographic microscope devices and methods. More particularly, the technical field relates to an ultraviolet (UV) holographic microscope device that is used to image crystals. The UV holographic microscope device enables a user to distinguish protein crystals from salt crystals.

### BACKGROUND

Protein crystallographers rely on dual-mode optical microscopes composed of bright-field and ultraviolet (UV) induced fluorescence modes to image protein crystals as well as to distinguish them from salt crystals that could form during the crystallization process. This distinction is mainly based on the response to the UV illumination, where most protein crystals absorb the UV light and emit fluorescence through tryptophan residues, unlike most salt crystals. In addition to UV fluorescence, the strong absorption of UV light within organic materials has been utilized as an inherent contrast agent in imaging tissue samples, cells, intracellular nucleic acids and proteins, viruses and protein aggregates, making UV microscopy an important tool for researchers. However, conventional lens-based UV microscopy is a relatively expensive imaging modality, requiring the use of relatively bulky optical components that are specially designed for UV wavelengths, in addition to UV light sources and UV-sensitive cameras for bright-field imaging, adding up to significant costs (e.g., $35,000-$200,000). See e.g., Gill et al., Evaluating the efficacy of tryptophan fluorescence and absorbance as a selection tool for identifying protein crystals, Acta Crystallograph. Sect. F Struct. Biol. Cryst. Commun, 66, 364-372 (2010). Furthermore, inherent limitations of lens-based microscopy also apply to conventional UV microscopes, where the trade-off between the field-of-view (FOV) and resolution limits the total sample area that can be imaged. Thus, not only are conventional UV-based microscopes bulky and expensive, these microscopes often are only able to image relatively large FOVs. This may require scanning of the sample over rather large areas which can be time-consuming and laborious. There thus is a need for an alternative UV-based microscope that addresses these challenges.

### SUMMARY

In one embodiment, a portable holographic imaging platform or system is provided. The platform or system includes a small, portable holographic imaging device that includes a housing or enclosure that contains one or more light sources emitting ultraviolet (UV) light that emit light along an optical path. A UV band-pass filter is optionally disposed in the housing or enclosure along the optical path to block the side-bands and let substantially pure UV light toward the sample. In one embodiment, the light has a wavelength of around 280 nm and around a 10 nm bandwidth. An image sensor (e.g., complementary metal-oxide-semiconductor (CMOS) image sensor) is located within the housing or enclosure along the optical path and is used to capture raw in-line hologram images of the crystals contained in a sample holder that is inserted into the housing or enclosure to place the sample along the optical path. The sample holder is typically placed very close to the image sensor (e.g., tens to hundreds of micrometers away from the image sensor active surface) while the one or more light sources are located much further from the sample holder (e.g., several centimeters). The interference between the light scattered from the target crystals and the background illumination create in-line holograms that are digitized/recorded by the image sensor. The portable imager device includes a computing device, digital circuitry, and/or microcontroller configured to control the one or more light sources and, in some embodiments, receive one or more images of the sample obtained from the image sensor. In some embodiments, a plurality of light sources may be used to synthesize or generate pixel super-resolved hologram images of the crystals that have higher spatial resolution, higher contrast, and/or higher signal-to-noise ratio as compared to the individual lower resolution images that are obtained by the image sensor when individual light sources are sequentially activated.

The images that are acquired or obtained by the image sensor are then subject to processing by image processing software executed on a computing device to digitally back-propagate the images of the sample containing crystals into corresponding amplitude and/or phase images of the sample. In some embodiments, the computing device that executes the image processing software may be part of the portable imaging device. In other embodiments, the computing device that executes the image processing software may be separate from the portable imaging device and is connected thereto via a wired or wireless connection. For example, images obtained with the portable holographic imaging device may be transferred to a computer such as a personal computer, laptop, tablet PC, server, virtual server, or the like for processing.

The protein-based crystals present in the sample appear dark while other non-protein crystals such as salt-based crystals do not exhibit the same dark appearance. The significantly larger contrast exhibited by the protein crystals is used to identify and distinguish protein crystals from non-protein crystals. Amplitude and/or phase images of the sample and crystals may be presented to the user on a display for viewing and/or analysis. In some embodiments, the image processing software may automatically identify those crystals in the sample that are protein crystals. This may be done by comparing the relative contrast levels of the imaged crystals against threshold values. For examples, crystals exhibiting UV contrast levels above a certain level may be characterized as protein crystals. The image processing software may also count or quantify the number and/or concentration of protein crystals in the sample. The images that are captured by the device have a large FOV that is limited only by the active area of the image sensor (e.g., >10 mm²).

In one embodiment, a method of imaging a sample containing crystals includes the operations of providing a portable holographic microscope comprising one or more light sources emitting ultraviolet (UV) light, an optional UV band-pass filter, an image sensor, and a microcontroller or on-board processor operatively communicating with the image sensor. A sample containing crystals is inserted into the portable holographic microscope and the sample is illuminated with filtered light (e.g., when filter is used) from the one or more light sources. One or more raw hologram images of the sample containing crystals are captured with the image sensor. In one particular embodiment, only a single raw hologram image is obtained (e.g., single shot mode of operation). The one or more raw hologram images are subject to digital back-propagation using image processing software executed using a computing device to obtain one or more amplitude and/or phase images of the sample. The one or more amplitude and/or phase images of the sample may be presented to the user for viewing and/or analysis.

In another embodiment, a portable holographic microscope includes a portable housing or enclosure containing one or more light sources emitting ultraviolet (UV) light, an optional UV band-pass filter, a sample holder configured to hold or receive a sample containing crystals therein, and image sensor. The portable holographic microscope includes a processor and/or microcontroller configured to control the one or more light sources and receive one or more images of the sample obtained from the image sensor.

In another embodiment, a portable holographic microscope system includes a portable housing or enclosure having one or more light sources emitting ultraviolet (UV) light along an optical axis within the housing. An optional UV band-pass filter is disposed along the optical axis within the housing. An image sensor is disposed along the optical axis within the housing. The portable holographic microscope includes a processor and/or microcontroller configured to control the one or more light sources and receive one or more images of the sample obtained from the image sensor. A sample holder is configured to hold or receive a sample containing crystals therein and is insertable into the housing to locate the sample holder along the optical axis and adjacent to the image sensor. The sample holder may be part of the housing or enclosure or it may be separate component or device that is insertable into the housing or enclosure. The system includes a separate computing device in communication with the processor or microcontroller of the portable housing, the separate computing device having image processing software executed thereon configured back-propagate the one or more images of the sample containing crystals into corresponding one or more amplitude and/or phase images of the sample. The one or more amplitude and/or phase images of the sample may then be displayed to the user on a display of the separate computing device or another display (e.g., a display of portable electronic device or other computing device).

### BRIEF DESCRIPTION OF THE DRAWINGS

FIG. 1 illustrates a system that includes a portable holographic microscope device that is used to obtain and/or acquire one or more raw hologram images of a sample that contain crystals therein which are then subject to image processing (e.g., back-propagation) to generate corresponding one or more amplitude and/or phase images of the sample containing the crystals.

FIG. 2 illustrates a sequence of operations that are used to operate the portable holographic microscope device/system of FIG. 1 according to one embodiment.

FIG. 3 illustrates one embodiment of a sample holder according to one embodiment.

FIG. 4A illustrates a photographic image of the UV-based holographic microscope. The UV LED is spectrally filtered using a band-pass filter to block the side-bands, letting through pure UV light with 280 nm peak wavelength and a 10 nm bandwidth towards the sample, which is placed very close to the image sensor (˜300-400 μm), utilizing the full active area as the imaging FOV (>10 mm²).

FIG. 4B illustrates a partial cut-away of a simplified schematic of the portable holographic microscope.

FIG. 5A illustrates brightfield microscope images of proteinase K, sodium chloride and ammonium sulfate crystals.

FIG. 5B illustrates amplitude reconstructions of the same FOVs in FIG. 5A, proteinase K crystals appearing significantly darker.

FIG. 5C illustrates x-ray diffraction data from the proteinase K, sodium chloride and ammonium sulfate crystal samples, with largest spacing values of 30 Å, 3.25 Å and 3.25 Å, respectively.

FIG. 6A illustrates the full FOV (>10 mm²) image captured by the portable holographic microscope system (FIGS. 1, 4A, 4B) where the rectangle shows a typical FOV possible using a lens-based UV microscope with a 5× objective lens.

FIG. 6B illustrates samples containing proteinase K and salt crystals (lithium acetate and lithium sulfate) in the same chamber, imaged by the lens-based UV microscope in both brightfield and UV fluorescence modes. The proteinase K crystals strongly absorb the 280 nm UV light and emit fluorescence, where the salt crystals do not.

FIG. 6C illustrates the corresponding amplitude reconstructions of the same FOVs captured by the portable holographic microscope system. The same crystals that emitted fluorescence in FIG. 6B appear significantly darker compared to the background due to the stronger absorption, while the crystals that did not emit fluorescence (i.e., salt crystals) do not show significant contrast in the amplitude reconstructions.

FIG. 6D is a graph showing how protein crystals show a significantly stronger UV contrast compared to salt crystals (p<0.02). The standard deviation bars represent the variation of the contrast within the rectangular regions used to calculate the average contrast of the target objects.

FIG. 7A illustrates images of protein crystals (RING1B complex and maltose binding protein crystals) obtained with lens-based UV microscope (brightfield and UV fluorescence) along with reconstructed UV images obtained with the portable holographic microscope described herein. Lithium acetate crystals (e.g., salt crystals) were used as control. The protein crystals showed fluorescence when imaged by the lens-based UV imaging platform, while the salt crystals did not show any significant fluorescence. In the same manner, amplitude reconstructions from of the protein crystals showed a significant contrast while the salt crystals did not.

FIG. 7B is a graph showing UV contrast for protein crystals (RING1B complex and maltose binding protein crystals) and salt crystals (lithium acetate). This significant contrast difference (p<0.003) clearly shows the efficacy of the portable holographic microscope system in differentiating protein crystals from salt crystals. The standard deviation bars represent the variation of the contrast within the rectangular regions used to calculate the average contrast of the target objects.

### DETAILED DESCRIPTION OF THE ILLUSTRATED EMBODIMENTS

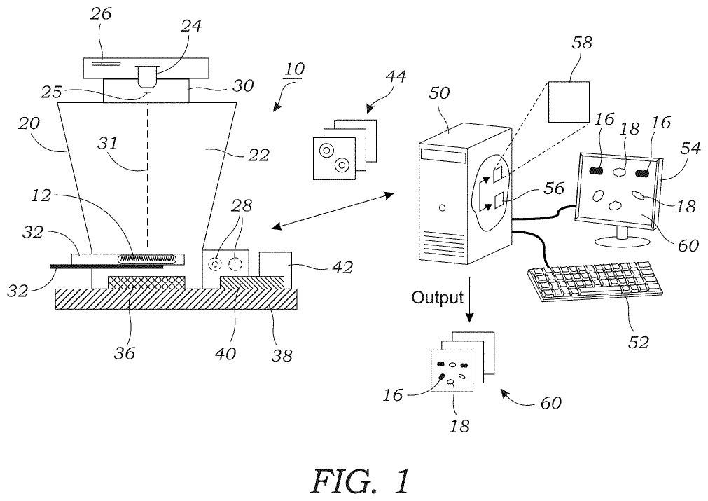

FIG. 1 illustrates a system 2 that includes a portable holographic microscope device 10 that is used to obtain and/or acquire one or more raw hologram images 44 of a sample 12 that contain crystals therein which are then subject to image processing (e.g., back-propagation as explained herein) to generate corresponding one or more amplitude and/or phase images 60 of the sample 12 containing the crystals. The one or more amplitude and/or phase images 60 which are output or generated display protein crystals 16 having a high degree of contrast (i.e., they appear dark in the amplitude image(s) 60). In contrast, non-protein crystals 18 do not have a high degree of contrast and appear lighter in the amplitude image(s) 60. In other embodiments, the phase image 60 may display a high degree of contrast with respect to certain crystals and may be generated instead of or in conjunction with amplitude image(s) 60. While the system 2 contemplates that multiple raw hologram images 44 may be obtained of the sample 12 it should be appreciated that only a single raw hologram image 44 is needed. Thus, in one embodiment, the system 2 operates on a “single shot” raw hologram image 44 obtained by the portable holographic microscope device 10.

The portable holographic microscope device 10 includes a housing or enclosure 20 that holds the components of the holographic microscope device 10. The portable holographic microscope device 10 is small and lightweight and may be carried around and moved easily by a person and does not need a designated bench area like a conventional microscope. The housing or enclosure 20 includes an interior portion 22 that is holds the various optical components and isolates any external ambient light from entering. The housing or enclosure 20 may be formed from a light-weight material such as a polymer or plastic although other materials may be used. With reference to FIG. 1, the housing or enclosure 20 includes one or more light sources 24 that are used to illuminate the sample 12 with ultraviolet (UV) light. The one or more light sources 24 may include one or more light-emitting diodes (LEDs) or laser diodes that emit light in the UV range. In one embodiment, the one or more light sources 24 includes a single deep UV LED operating at a peak wavelength of around 280 nm. It should be appreciated that the one or more light sources 24 may operate within a range of wavelengths within the UV range and not necessarily at a single wavelength. The reason why a peak wavelength of around 280 nm is used is because protein crystals 16 strongly absorb UV light at this wavelength due to the presence of the amino acids, tryptophan, tyrosine, and cysteine. Salt crystals 18 do not absorb UV radiation at this wavelength. If multiple light sources 24 are used, an aperture or hole 25 is provided adjacent to the multiple light sources 24 (e.g., between the light sources 24 and the UV band-pass filter 30) to avoid shadowing effects on the image sensor 36. The aperture or hole 25 is optional, however and is not needed, for example, when a single light source 24 is used.

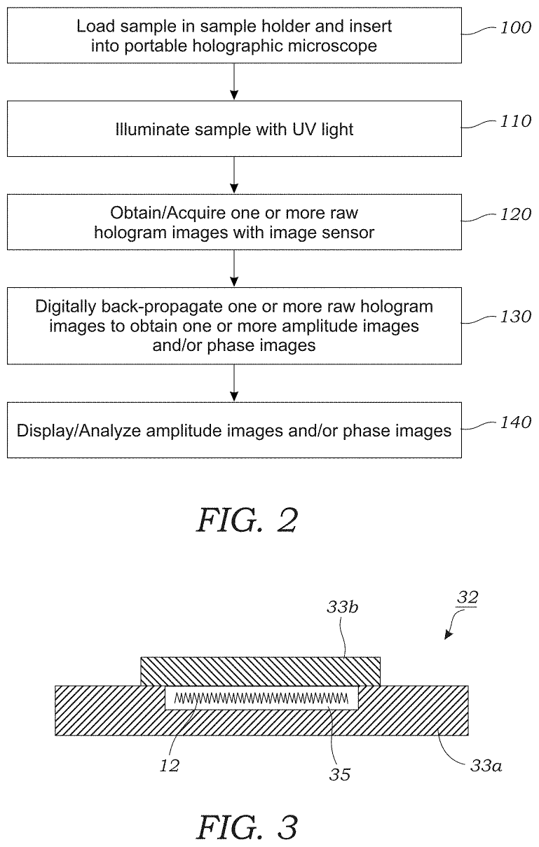

In addition, in another alternative embodiment, there are a plurality of light sources 24 used to illuminate the sample 12. The plurality of light sources 24 may be arranged in an array generally orthogonal to the optical axis or path 31. The plurality of light sources 24 may optionally be coupled to respective optical fibers that terminate in an array or pattern of fibers (e.g., rows and columns or other two-dimensional pattern) that are sequentially illuminated by each of the plurality of light sources 24. One or more separate raw holographic images 44 are captured with the image sensor 36 for each of the plurality of light sources 24. The laterally offset light sources 24 (in the x, y plane) can then be used in a pixel super-resolution process whereby the lower resolution shifted holographic images 44 are then subject to a pixel-super resolution process to generate holographic images 44 with higher spatial resolution, higher contrast, and/or higher signal-to-noise ratio (snr). These higher resolution images 44 can then be digitally back-propagated to create the amplitude and/or phase images 60 as described and illustrated in the context of FIG. 2. Pixel super-resolution is a computational method that synthesizes a higher resolution image from a set of sub-pixel shifted lower resolution images of the same scene or object. The relative shifts together with the lower resolution holographic images 44 are provided as inputs to a least-square optimization problem to estimate the higher resolution (super-resolved) hologram. Details regarding pixel super-resolution may be found, for example, in Greenbaum et al., Field-Portable Pixel Super-Resolution Colour Microscope, PLoS ONE 8(9): e76475. doi:10.1371/journal.pone.0076475 (2013) and Bishara et al., Holographic pixel super-resolution in portable lensless on-chip microscopy using a fiber-optic array, Lab Chip 11: 1276-1279 (2011), which are incorporated herein by reference.

LED driver circuitry 26 may be used to drive the one or more light sources 24 although such circuitry may be incorporated into the microcontroller or processor 40 located on the printed circuit board (PCB) 38 as described below. LED driver circuitry 26 may also be omitted entirely and the LED light source 24 driven directly. The one or more light sources 24 may be powered using a power source 28 such as one or more batteries that are associated with the portable holographic microscope device 10. Power may also be provided via a dedicated power cord or through a communication cable that is also used for data/image transfer (e.g., USB cable).

The portable holographic microscope device 10 includes an optional UV band-pass filter 30 that is used to block the side-band emissions from the one or more light sources 24. The UV band-pass filter 30 is located along an optical axis or path 31 that extends from the one or more light sources 24 and through the interior 22 of the housing or enclosure 20. As seen in FIG. 1, a sample holder 32 that contains the sample 12 is interposed in the optical axis or path 31 and receives the filtered UV light. The sample holder 32 may include a three-dimensional volume that holds a liquid containing crystals therein. The sample holder 32 may include a cuvette, tube, capillary, chamber, well or slide-based sample holder 32 that is used to hold crystal samples. For example, in one embodiment, a three-dimensional sample chamber is formed between UV-fused silica slides and standard poly-chloro-tri-fluoro-ethylene (PCTFE), e.g., ACLAR® covers containing a well therein. The sample holder 32 is preferably optically transparent to UV radiation to allow the UV filtered light to illuminate the sample 12. The sample holder 32 may, in some embodiments, be positioned on a tray or support 34 that can move the sample 32 into/out of the housing or enclosure 20.

FIG. 3 illustrates one embodiment of a sample holder 32 that includes a lower substrate 33a that includes a well or chamber 35 formed therein for holding the sample 12. An upper substrate 33b is disposed atop the lower substrate 33a and maintains the fluid sample 12 inside the well or chamber 35. Both the lower substrate 33a and the upper substrate 33b are substantially optically transparent to UV light. For example, the lower substrate 33a may be formed from PCTFE and the upper substrate 33b may be a glass slide or coverslip. The sample holder 32 is then insertable into the housing or enclosure 20 of the portable holographic microscope device 10 either directly or using the tray or support 34.

As seen in FIG. 1, an image sensor 36 is disposed in the interior 22 of the housing or enclosure 20 and is aligned in the optical axis or path 31 with the sample holder 32 containing the sample 12 being interposed between the image sensor 36 and the one or more light sources 24. The image sensor 36 may include, in one embodiment, a complementary metal-oxide-semiconductor (CMOS) image sensor 36. The image sensor 36 may include a monochrome or color image sensor 36. The image sensor 36 may include a color image sensor 36 with but only one color of pixels values being retained (e.g., green) for image processing. The location of the sample holder 32 with the sample 12 is disposed adjacent or close to the active area of the image sensor 36. Typically, the sample 12 is placed tens to hundreds of microns away from the active area of the image sensor 36 (e.g., 200-600 μm). The one or more light sources 24 are, in contrast, located much further away from the sample holder 32 and sample 12. Typically, the one or more light sources 24 (and optional aperture or hole 25) are located several centimeters away from the sample holder 32 and the sample 12. In this configuration, the active area of the image sensor 36 is fully utilized as the imaging FOV (e.g., >10 mm²) and the filtered UV light is scattered through the sample 12, generating in-line holograms through its interference with the background light captured by the image sensor 36. It is these raw holographic images 44 are then digitally processed to extract the amplitude and/or phase information encoded in the interference patterns from the objects (e.g., crystals 16, 18) in the sample 12.

Still referring to FIG. 1, the image sensor 36 is located on a printed circuit board (PCB) 38 or other substrate. The PCB 38 may also hold a microcontroller or one or more processors 40 that are used to operate the electronics of the portable holographic microscope 10. This includes operating the one or more light sources 24 and the image sensor 36. The microcontroller or one or more processors 40 are also used to store the raw holographic images 44 obtained by the image sensor 36. These may be stored in memory (not shown) associated with the microcontroller or processor(s) 40. The microcontroller or processor(s) 40 is/are also used to control transfer of raw holographic images 44 to a separate computing device 50 as described in more detail herein. One or more communication ports 42 (e.g., LAN or USB ports) may be provided on the PCB 38 for the transfer of images/data from/to the portable holographic microscope 10. Alternatively, the microcontroller or processor(s) 40 may include wireless functionality (e.g., Wi-Fi, Bluetooth, or the like) such that image files 44 and data can be transferred wirelessly to the separate computing device 50.

As seen in FIG. 1, the separate computing device 50 may include a personal computer, laptop, server, virtual server, or even a portable electronic device such as a Smartphone. The computing device 50 includes one or more processors 56 and, in some embodiments, one or more optional graphics processing units (GPUs). The separate computing device 50 may be co-located with the portable holographic microscope 10 or it may be located remote from the portable holographic microscope 10 (e.g., a server located in a different geographic area). The computing device 50 may have one or more input devices 52 and a display 54 (which may also be in input device 52 in some embodiments) for displaying the back-propagated amplitude and/or phase images 60 of the sample 16. The display 54 may be separate display or integrated into the computing device 50 (e.g., screen of a Smartphone, tablet PC, iPad, and the like). The computing device 50 includes one or more processors 56 and image processing software 58 that is executed using the one or more processors 56. In one embodiment, the image processing software 58 is configured to receive as inputs the raw holographic image(s) 44 and back-propagate the holographic image to a plane within the sample 12 (or objects within the sample 12) and output amplitude and/or phase images 60. The back-propagated amplitude and/or phase images 60 may then be displayed on the display 54 such as seen in FIG. 1. The amplitude and/or phase images 60 show the protein-based crystals 16 as dark while the non-protein crystals (e.g., salt crystals) 18 do not appear dark.

The image processing software 58 may be implemented in any number of languages or programs. The examples described herein utilized MATLAB (MathWorks, MI, USA) although it should be appreciated that other languages and programs may be used. Examples include, for example, Python, C++, and the like. In one embodiment, the image processing software 58 software is configured to automatically identify protein crystals 16 from non-protein crystals based at least in part on the measured contrast of crystals identified in the one or more amplitude and/or phase images 60 of the sample 12. For example, different crystals 16, 18 in the amplitude and/or phase image 60 may be segmented using the image processing software 58 and then their respective contrast values (within the segmented regions or a portion thereof) measured and compared to a threshold value. The threshold value may be set empirically based on known samples with protein-based crystals 16 and non-protein crystals 18 being analyzed with the system 2. Those crystals within the amplitude and/or phase image 60 that have average, mean, or the like UV contrast values that exceed this threshold may be identified as protein crystals 16 while those that do not exceed the threshold may be identified as non-protein crystals 18.

FIG. 2 illustrates a method of imaging a sample 12 containing crystals 16, 18 according to one embodiment. In operation 100, the sample 12 that contains crystals 16, 18 is loaded into the sample holder 32. The sample 12 may include a biological sample such as a biological fluid or extract of a biological fluid. The sample 12 may also be contained in one or more buffer solutions used, for example, for crystallography synthesis or research applications. The sample 12 may also include an environmental sample or a sample of a reaction product or process. The sample 12 is typically in contained in an aqueous-based fluid and contains the crystals 16, 18 therein. The crystals 16, 18 thus may be contained in a carrier fluid. The carrier fluid may include conventional buffered solutions, aqueous solutions, or even biological fluid. The sample holder 32 is then inserted into the housing or enclosure 20 of the portable holographic microscope 10. This may be done by directly inserting the sample holder 32 into the housing or enclosure 20. Alternatively, the sample holder 32 may be loaded into a moveable tray or support 34 on which the sample holder 32 rests and is moved into the optical path within the housing or enclosure 20. Next, as seen in operation 110, the sample 12 is then illuminated with UV light from the one or more light sources 24. This may be filtered UV light or unfiltered UV light. Next, in operation 120, the image sensor 36 acquires or obtains one or more raw hologram images 44. These image(s) 44 may be temporarily stored in locally in the portable holographic microscope 10 and then transferred to the separate computing device 50 or they may be immediately transferred to the separate computing device 50. Alternatively, in another embodiment, the images 44 are back-propagated using the microcontroller or one or more processors 40 of the portable holographic microscope 10, thus eliminating the need to transfer the raw hologram image(s) 44 to a separate computing device 50.

Once in the computing device 50 (or using the microcontroller or one or more processors 40), the raw hologram image(s) 44 is/are subject to a digital back-propagation operation as seen in operation 130 where the image processing software 58 digitally back-propagates the one or more raw hologram images 44 to one or more amplitude and/or phase images 60. The angular spectrum method is a technique for modeling the propagation of a wave field and involves expanding a complex wave field into a summation of an infinite number of plane waves. The hologram is first transformed to the spatial frequency domain using a fast Fourier transform (FFT). Then a phase factor, which is a function of the wavelength, propagation distance, and refractive index of the medium, is multiplied with the angular spectrum. Finally, it is inverse-Fourier-transformed to the spatial domain to obtain the back-propagated image of the sample 12. The back-propagated amplitude and/or phase images 60 at the object plane (i.e., within the sample 12) are then displayed and/or analyzed as seen in operation 140 in FIG. 1. Analysis may include automatically identifying protein crystals 16 and/or non-protein crystals 18 in the sample 12. The analysis may also include counting or quantifying the number or amount of protein crystals 16 (or non-protein crystals 18) in the sample 12. Alternatively, the Fresnel propagation method could be used for back-propagation using a single FFT, however with limited resolution as it is based on the Fresnel approximation. See e.g., Gorocs et al., On-Chip Biomedical Imaging, IEEE Reviews in Biomed. Eng., Vol. 6, pp. 29-46 (2012), which is incorporated herein by reference.

In another embodiment, one or more additional light sources 24 may be included in the portable holographic microscope 10 that emit light in the visible portion of the electromagnetic spectrum. These one or more additional lights sources 24 would be located after any band-pass filter 30 and can be used to provide additional information on the sample 12 from a different channel (e.g., blue, red, or green light) which could be used with the UV images 60 to assess change in contrast, etc. to provide another dimension for crystal assessment.

Experimental

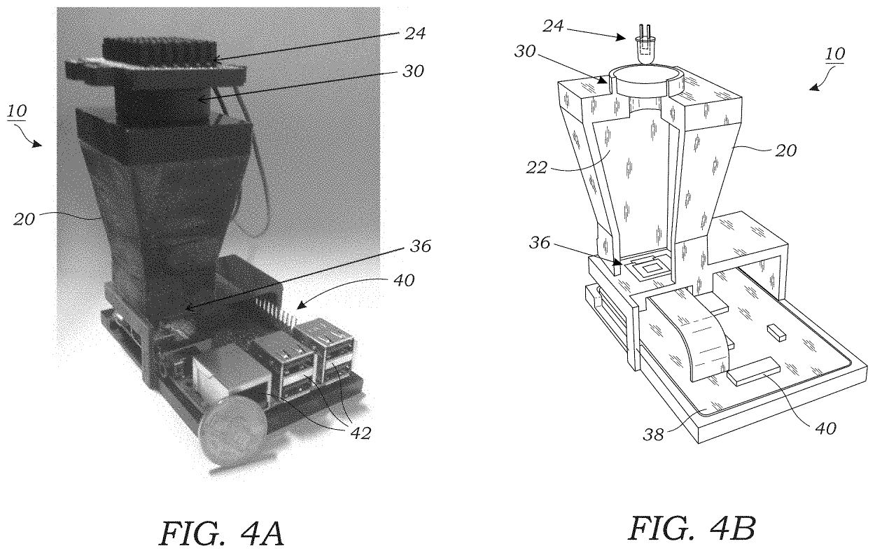

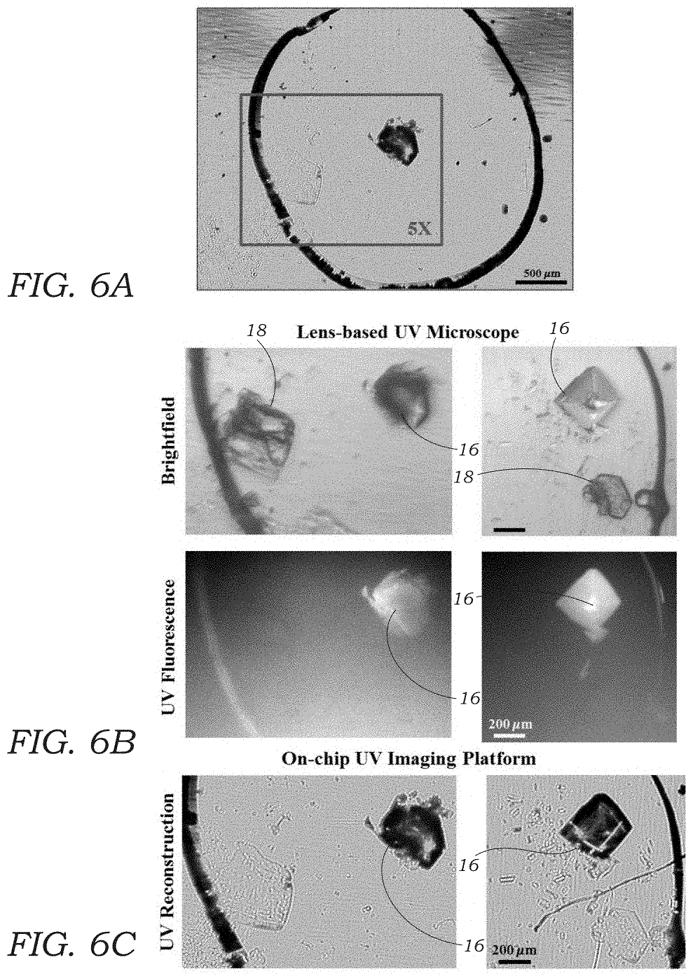

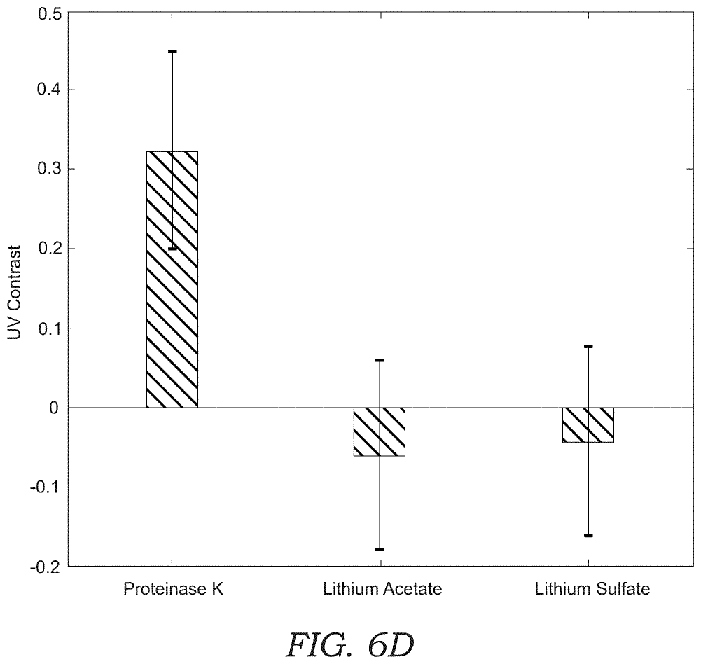

The portable holographic microscope 10 that was tested (FIGS. 1, 4A, 4B) was built upon the versatile Raspberry Pi 3 board/microcontroller 40, with its readily available 8 Megapixel CMOS camera, all housed within a custom-designed and 3D printed housing or enclosure 20 which also holds a UV LED light source 24 operating at 280 nm peak wavelength with a band-pass filter 30 to block the side-band emissions. It should be appreciated that the Raspberry Pi 3 is only one example and other microcontrollers/processors 40 or control circuitry may be used to power and control the light source 24 and image sensor 36. In the particular embodiment using the Raspberry Pi 3 board/microcontroller 40, the CMOS camera is de-capped, removing the lens module, and the sample is placed very close (˜300-400 μm) to the active area of the image sensor 36 that is fully utilized as the imaging FOV (>10 mm², FIG. 6A). The filtered UV light is scattered through the sample 12, generating in-line holograms through its interference with the background light that is captured by the image sensor 36. These holographic images 44 are then digitally processed to extract the amplitude and/or phase information encoded in the interference patterns from the target objects in the sample 12 and amplitude and/or phase images 60 are generated.

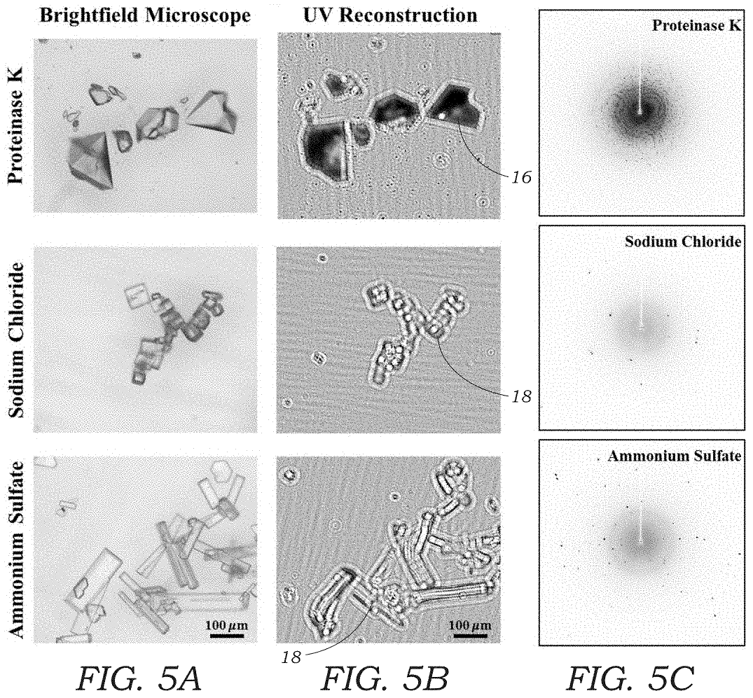

The portable holographic microscope 10 was tested to verify the effect of strong UV absorption in the amplitude reconstructions, imaging protein crystals (FIG. 5B). Samples 12 were prepared by constructing imaging chambers 32 using UV fused silica glass slides and pieces of ACLAR® protein crystallization covers, a standard material used by protein crystallographers which is also UV transparent. It is important to note that, additional consideration has to be given in the transparency of materials for coherent imaging modalities like holography, as the irregularities in the material volume could result in strong background distortions. The standard UV transparent ACLAR® used by protein crystallographers is suitable for holographic imaging, only creating a faint modulation in the background (FIG. 5B) which does not affect the imaging quality.

The imaging platform (FIGS. 1, 4A, 4B) was first tested by preparing a sample with proteinase K, a serine protease readily available for crystallization, which contains aromatic amino acids that fluoresce when excited at 280 nm light, and two salt crystal samples (sodium chloride and ammonium sulfate) (FIGS. 5A and 5B), where the respective X-ray diffraction data are shown in FIG. 5C. Individual crystals were pipetted along with ˜1 μL of solution on to the ACLAR® piece (sticky side facing up), and a UV fused silica was used to seal the droplet into the chamber 32. The amplitude reconstructions 60 of the holograms 44 clearly show that the protein crystals appear much darker compared to the background, unlike the salt crystals (FIG. 5B). The amplitude reconstruction images 60 shown in FIG. 5B could be further improved using additional phase-retrieval techniques to mitigate twin-image artifacts, however, this may be at the cost of additional computation and/or holographic measurements. While the particular crystals imaged herein used amplitude reconstruction images 60 it should be appreciated that other crystal samples may use phase reconstruction images 60 or a combination of both amplitude and phase reconstruction images 60.

To further evaluate the portable holographic imaging system 2, mixed-samples were imaged containing both protein (proteinase K) and salt crystals (lithium acetate and lithium sulfate) within the same FOV (FIGS. 6A-6D), prepared by sandwiching droplets of ˜1 μL buffer solution containing the crystals between a UV fused silica slide and a piece of ACLAR® sheet. The crystals were grown in their respective buffer solutions and then individually fished by a micro loop and deposited in the droplet before sealing. The samples 12 where first imaged with the lens-based microscope (FIG. 6B), which is able to distinguish between the protein and salt crystal through the fluorescence of the protein crystal, where the protein crystal is observed to be emitting fluorescence while the salt crystal remains dark. The samples were then imaged with the portable holographic microscope (FIGS. 6A, 6C), where the proteinase K crystals showed a significantly stronger contrast (p<0.02) compared to the salt crystals (FIGS. 6C and 6D). The contrast (C) in the UV holographic amplitude reconstructions was calculated by subtracting the average amplitude signal of the target crystals (S_{c}) from the average background signal value (S_{b}) and dividing this difference by the average background signal value, i.e.,

$$C = \frac{{S}_{b} - {S}_{c}}{{S}_{b}} , \qquad ( 1 )$$

where S_{c} is calculated within the largest rectangular region that fits inside the target crystal and S_{b} is calculated within a clear region of the FOV that does not contain any objects.

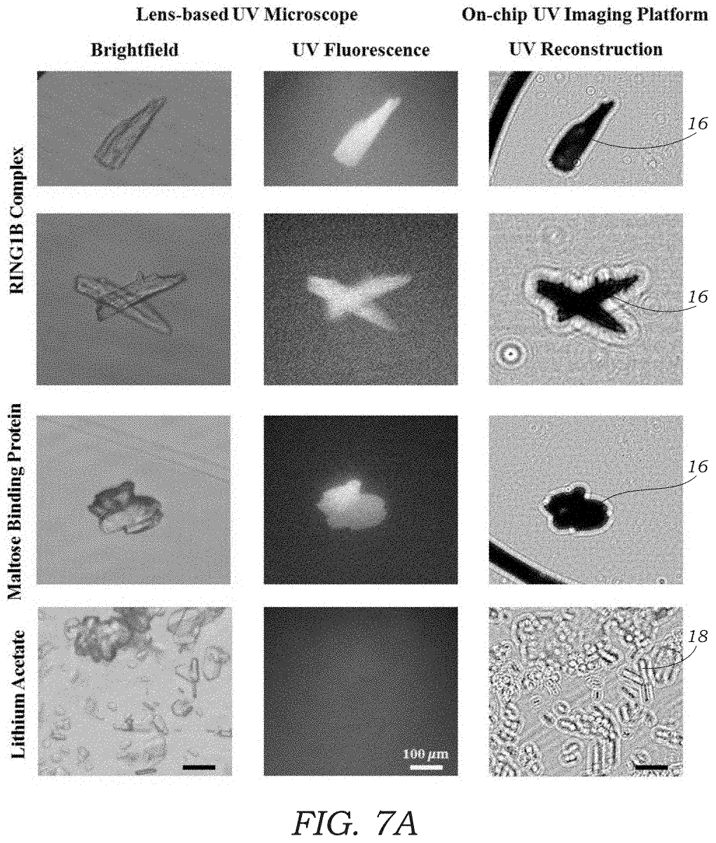

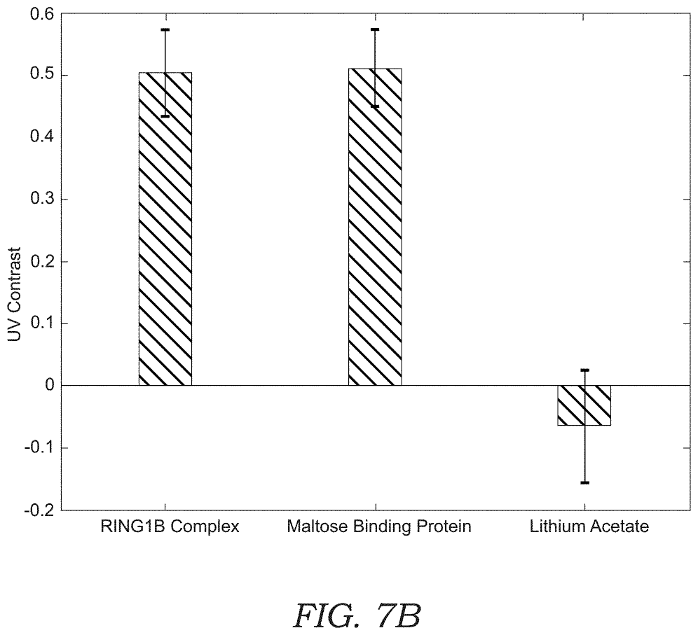

To further test the imaging capabilities of the portable holographic microscope 10 for protein crystallography, additional experiments were performed using (1) the RING1B complex, which is associated with the nuclear membrane and participates in histone ubiquitination in humans, and (2) the maltose binding protein, which breaks down maltodextrins in Escherichia coli and also forms UV active crystals, (FIGS. 7A and 7B). All the samples under test were imaged by the lens-based UV microscope first (FIG. 7A—left two columns) and then by the UV-based portable holographic microscope 10 (FIG. 7A right column and FIG. 7B). The capabilities of the portable UV imaging platform in distinguishing between protein and salt crystals was further verified with these different types of proteins, which showed a significantly higher contrast (p<0.003) compared to salt crystals (lithium acetate) (FIG. 7B).

The portable holographic microscope 10 and system 2 disclosed herein is an alternative to the expensive and bulky dual-mode UV microscopes used by protein crystallographers. The portable holographic microscope system 2 can be even further strengthened with near real-time imaging capabilities, driven by improvements in deep UV LED power output efficiencies enabling the use of lower sensor integration times and the increasing availability of embedded graphics processing units (GPUs) as the one or more processors 56 for single-board computers.

In addition, while the raw holographic images 44 were offloaded to a separate computing device 50 for back-propagation by the image processing software 58 it should be appreciated that, in other embodiments, the back-propagation may take place on the microcontroller or processor(s) 40 that reside locally with the portable holographic microscope 10. For example, back-propagation may be implemented in Python which is executed on-bard by the microcontroller or processor(s) 40, thereby avoiding the need to offload or transfer the raw holographic images 44 to a separate computing device 50 for image processing.

UV On-Chip Imaging Platform

The portable holographic microscope 10 (FIGS. 1, 4A, 4B) is composed of a de-capped 8 Mega-pixel (3280 horizontal×2464 vertical, with an active area of 10.14 mm²), 1.12 μm pixel pitch, CMOS image sensor (IMX219, Sony Corporation, Tokyo, Japan) interfaced to a Raspberry Pi 3B single-board computer (microcontroller/processor 40), a deep UV LED light source 24 operating at 280 nm peak wavelength (TH-UV280J9-C-H-B, Tianhui Optoelectronics Co., Ltd, Guangdong Province, China) and a UV band-pass filter with a center wavelength of 280 nm and a bandwidth of 10 nm (FF01-280/10-25, Semrock, NY, USA) to block the side-band emissions from the UV LED light source 24. All of these components are housed within a custom designed and 3D printed acrylonitrile butadiene styrene (ABS) (Stratasys, Dimensions Elite) housing or enclosure 20. A custom Python script was used to capture, extract and save the raw frames/holograms 44 from the image sensor 36 to the onboard storage of the Raspberry Pi 3B.

Data Processing

Because the green pixels of the image sensor were 36 most responsive to the UV illumination, the values in the red and blue pixels of the raw holographic image frames 44 were replaced with the average of their neighboring green pixels. The image frames 44 containing holographic projections were then digitally back-propagated using the angular spectrum approach, numerically solving the Rayleigh-Sommerfeld integral by multiplying the Fourier transform of the hologram with the transfer function of wave propagation, generating the amplitude and/or phase images 60 of the sample 12. The complete data processing takes ˜1 minute using a standard desktop computer 50 (Dell Optiplex 9010, Intel i7, 32 GB RAM) operating MATLAB (MathWorks, MI, USA). The statistical significance of the increased contrast in the amplitude reconstructions of protein crystals compared to salt crystals was verified using a t-test with two separate experiments for proteinase K (FIG. 6D) and three separate experiments for the additional set of proteins which included the RING1B complex and the maltose binding protein (FIG. 7A).

Sample Preparation

UV compatible materials which include UV fused silica slides (10 mm×10 mm, 0.2 mm thick, MTI Corp., CA, USA) and pieces of standard protein crystallization covers made of ACLAR® composed of poly-chloro-trifluoroethylene (Grace Bio-Labs ProCrystal Cover 875238, OR, USA) were used to construct the sample chambers 32 holding the crystal samples 12. A 0.8-1 μL droplet containing the crystals and the corresponding buffer solution was deposited onto an ACLAR® piece containing one well, sticky side facing up. A UV fused silica slide was then gently used to cover the well, sealing the droplet in the sample holder 32. It is noteworthy that the ACLAR® standard protein crystallization cover material was suitable for coherent imaging, and only resulted in a faint background modulation (FIG. 5B) which did not affect the image quality.

Protein and Salt Crystallization

A TTP LabTech Mosquito (TTP Labtech Inc., MA, USA) was used to generate 96-well hanging drop crystallization setups. All protein crystals were grown in a manner of days using vapor diffusion. Proteinase K (VWR catalog number 97062-238, PA, USA) was crystallized by dissolving lyophilized powder in water to obtain a 50 mg/ml stock. The stock solution was mixed 1:1 with 1.5 M ammonium sulfate and 0.1 M Tris-HCl pH 7.5. Maltose binding protein 80 mg/ml in 20 mM Tris-HCl pH 8.0 and 50 mM NaCl was crystallized by mixing 1:1 with 0.2 M magnesium chloride hexahydrate, 0.1 M MES pH 6.0, and 20% w/v PEG 6000. Oligomerization regions of RING1B, PCGF4, CBX8 and PHC1 were supplied by the Chemistry and Biochemistry Department at UCLA. This sample was mixed 1:1 with 0.7 M sodium formate pH 7.0 and 20% w/v PEG 3350. All 300 nL drops were equilibrated over 100 μL the corresponding crystallization solutions. 1.0 M sodium chloride, 2.0 M ammonium sulfate, 1.0 M lithium acetate and 1.0 lithium sulfate were dispensed in μL microliter aliquots and allowed to evaporate in air while being observed in a stereomicroscope. Crystals that formed by dehydration in aqueous solution were manually harvested using 50 micron micro loops (Mitegen M5-L18SP-SOLD, NY, USA) and placed in 1 μL of the stock salt solution. These solutions, containing crystals, were placed on the ACLAR® surface by pipette for imaging.

Lens-Based UV Microscopy

A dual-mode UV microscope (Korima PRS-1000, CA, USA) was used for comparison with the portable holographic imaging system 2. Samples were imaged with the UV microscope first and then holographically imaged with the portable holographic microscope 10. Crystals were exposed to 280 nm light for no more than five seconds and the images taken were compared with the corresponding reconstructed holographic images (FIG. 7A).

X-ray Diffraction

To further distinguish protein crystals from salt, diffraction images were taken. Individual crystals from the target sample were harvested and placed in their mother liquor with 33% glycol added to resist the formation of crystalline water. A rotating anode generator (Rigaku FRE+, Tokyo, Japan) and an imaging plate detector (Rigaku HTC, Tokyo, Japan) were employed for X-ray data collection. Macromolecule crystals are distinguishable from salt crystals by lower resolution reflections that occur as the result of larger spacing between symmetric elements of the crystal (FIG. 5C).

A low-cost and portable holographic microscope 10 was designed and built that operates at the deep UV wavelength of 280 nm for high-contrast imaging of protein crystals. Without the need for sensitive, bulky and costly components, the system 2 offers a low-cost, high-throughput and robust alternative to the dual-mode optical microscopes composed of bright-field and ultraviolet (UV) induced fluorescence modes that are routinely used by protein crystallographers to image protein crystals and to distinguish them from salt crystals. The portable holographic microscope 10 was tested by imaging different protein crystals including proteinase K, maltose binding protein and the RING1B complex in comparison to several different salt crystals which include sodium chloride, ammonium sulfate, lithium acetate and lithium sulfate. While the amplitude reconstruction images 60 of the protein crystals appear much darker compared to the background, the salt crystals do not show any contrast, clearly distinguishing between the two types of crystals. The portable holographic microscope 10 can aid protein crystallographers and others as a low-cost and robust alternative platform to image protein crystals and to distinguish them from salt crystals.

While embodiments of the present invention have been shown and described, various modifications may be made without departing from the scope of the present invention. The invention, therefore, should not be limited, except to the following claims, and their equivalents.

1. A method of imaging a sample containing crystals comprising:
providing a portable holographic microscope comprising one or more light sources emitting ultraviolet (UV) light, a UV band-pass filter, an image sensor, and a microcontroller or on-board processor operatively communicating with the image sensor;
inserting a sample containing crystals into the portable holographic microscope and illuminating the sample with filtered light from the one or more light sources;
capturing one or more raw hologram images of the sample containing crystals with the image sensor; and
subjecting the one or more raw hologram images to digital back-propagation using image processing software executed using a computing device to obtain one or more amplitude and/or phase images of the sample.

2. The method of claim 1, wherein at least some of the crystals comprise protein crystals.

3. The method of claim 1, wherein the sample comprises a mixture of protein crystals and salt crystals.

4. The method of claim 1, wherein the one or more raw hologram images are temporarily stored on the microcontroller or on-board processor and transferred to a second computing device containing the image processing software.

5. The method of claim 1, wherein the image sensor comprises a color image sensor or a monochrome image sensor.

6. (canceled)

7. The method of claim 1, wherein the one or more light sources comprises one or more UV light emitting diodes (LEDs).

8. The method of claim 1, wherein the sample is contained in a separate optically transparent sample holder that is inserted into the portable holographic microscope.

9. The method of claim 8, wherein the sample holder defines a three-dimensional volume for holding a liquid sample containing the crystals.

10. The method of claim 1, wherein the one or more amplitude and/or phase images of the sample are displayed on a display associated with the on-board computing device or a separate computing device.

11. The method of claim 1, wherein the microcontroller or on-board processor executes the image processing software.

12. The method of claim 1, wherein the image processing software is configured to identify protein crystals from non-protein crystals based at least in part on the measured contrast of crystals identified in the one or more amplitude and/or phase images.

13. The method of claim 12, wherein the image processing software is configured to identify protein crystals based whether the measured contrast of crystals identified in the one or more amplitude and/or phase images exceed a threshold value.

14. The method of claim 1, wherein the digital back-propagation is performed using the angular spectrum method or the Fresnel propagation method.

15. The method of claim 1, wherein a plurality of light sources are sequentially illuminated to obtain corresponding sub-pixel shifted raw hologram images that are subject to a pixel super-resolution process to generate, with the image processing software, one or more hologram images having one or more of higher spatial resolution, higher contrast, and/or higher signal-to-noise ratio.

16. A portable holographic microscope comprising:
a portable housing containing:
a one or more light sources emitting ultraviolet (UV) light;
a UV band-pass filter;
a sample holder configured to hold or receive a sample containing crystals therein;
an image sensor; and
a processor and/or microcontroller configured to control the one or more light sources and receive one or more images of the sample obtained from the image sensor.

17. The portable holographic microscope of claim 16, further comprising a second computing device in communication with the processor or microcontroller of the portable housing, the second computing device having image processing software executed thereon configured back-propagate the one or more images of the sample into corresponding one or more amplitude and/or phase images of the sample.

18. The portable holographic microscope of claim 17, wherein the second computing device comprises a local computing device or a remote computing device.

19. (canceled)

20. The portable holographic microscope of claim 16, further comprising a sample chamber configured to hold a volume of the sample.

21. The portable holographic microscope of claim 16, further comprising one or more light sources emitting visible light.

22. The portable holographic microscope of claim 17, wherein the portable housing contains a plurality of light sources that are sequentially illuminated to obtain corresponding sub-pixel shifted raw hologram images and wherein the image processing software is configured to generate one or more pixel super-resolution hologram images having one or more of higher spatial resolution, higher contrast, and/or higher signal-to-noise ratio.

23. A portable holographic microscope system comprising:
a portable housing comprising one or more light sources emitting ultraviolet (UV) light along an optical axis within the housing;
a UV band-pass filter disposed along the optical axis within the housing;
an image sensor disposed along the optical axis within the housing;
a processor and/or microcontroller configured to control the one or more light sources and receive one or more images of the sample obtained from the image sensor;
a sample holder configured to hold or receive a sample containing crystals therein and insertable into the housing to locate the sample holder along the optical axis and adjacent to the image sensor; and
a separate computing device in communication with the processor or microcontroller of the portable housing, the separate computing device having image processing software executed thereon configured back-propagate the one or more images of the sample containing crystals into corresponding one or more amplitude and/or phase images of the sample.

24. The system of claim 23, further comprising a display configured to display the corresponding one or more amplitude and/or phase images of the sample.

25. The system of claim 24, wherein the image processing software is configured to identify protein crystals from non-protein crystals based at least in part on the measured contrast of crystals identified in the one or more amplitude and/or phase images of the sample.

26. The system of claim 25, wherein the image processing software is configured to identify protein crystals based whether the measured contrast of crystals identified in the one or more amplitude and/or phase images of the sample exceed a threshold value.

27. The system of claim 23, further comprising one or more light sources emitting visible light.

28. The portable holographic microscope of claim 23, wherein the portable housing contains a plurality of light sources that are sequentially illuminated to obtain corresponding sub-pixel shifted raw hologram images and wherein the image processing software is configured to generate one or more pixel super-resolution hologram images having one or more of higher spatial resolution, higher contrast, and/or higher signal-to-noise ratio.
